(19) United States
(12) Patent Application Publication
(10) Pub. No.: US 2005/0025692 A1
(43) Pub. Date: Feb. 3, 2005

(54) Methods and apparatus for small-scale synthesis of ammonia

(75) Inventors: Dawn M. Becher, Random Lake, WI (US); Fred J. Begale, Oconomowoc, WI (US); Reg F. Crane, Elwick (GB); Wayne S. Kaboord, Mequon, WI (US); Mohan S. Radhamohan, Novi, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Eaton Corporation (JK)

(21) Appl. No.: 10/838,586

(22) Filed: May 4, 2004

Related U.S. Application Data
(60) Provisional application No. 60/467,871, filed on May 5, 2003.

(51) Int. Cl. C01C 1/04

(52) U.S. Cl. 423/359; 422/148

(57) ABSTRACT

The present invention comprises, without limitation, an on-board micro ammonia plant that offers a solution of NOx reduction without the hazards and inconvenience of carrying a secondary fluid on the vehicle. Thus, one embodiment of the present invention comprises a micro ammonia plant that controllably produces and stores ammonia that is used to reduce NOx levels in the exhaust streams of internal combustion engines.

### CROSS-REFERENCE TO RELATED APPLICATIONS

This application claims priority based on U.S. Provisional Patent Application No. 60/467,871, filed May 5, 2003, which is hereby incorporated by reference in full.

### FIELD OF THE INVENTION

The present invention relates generally to the field of small-scale generation of ammonia.

### BACKGROUND OF THE INVENTION

A by-product of the combustion process is often the production of nitrogen oxides (“NOx”). (For all purposes herein, nitrogen oxides or NOx shall comprise all forms of N_{y}O_{z}, where y and z are respectively and independently 1 or greater.) Large amounts of nitrogen oxides are formed in combustion processes that incorporate air because nitrogen is present in both fuel and air. As combustion temperature increases, so does the formation of nitrogen oxides.

The most common oxides are NO (nitrogen monoxide) and NO₂ (nitrogen dioxide). NO is the dominant nitrogen oxide in exhaust gases. In the atmosphere NO rapidly oxidizes into NO₂. Nitrogen oxides are believed to have a negative impact on the environment, contributing to “acid rain” and causing the formation of photochemical oxidants (such as ozone).

There is a great need for devices and strategies to control NOx production and emissions. Sources of NOx include open and internal combustion processes that are used to provide power for industry, transportation, human comfort, and waste reduction. Many of these are operated in a manner that generates at least a small concentration of NOx in exhaust gases. As a consequence, a large effort is focused on the removal of NOx from the exhaust gases by after-treatment.

One strategy to reduce NOx emissions involves selective catalytic reduction (“SCR”). SCR is often used to reduce nitrogen oxide emissions from the internal combustion engines of motor vehicles. In the SCR process, nitrogen oxides are reduced primarily through the following reactions:

Catalyst

| | | |
|---|---|---|
| NO + NO₂ + 2NH₃ | → | 2N₂ + 3H₂O |
| 4NO + 4NH₃ + O₂ | → | 4N₂ + 6H₂O |
| 2NO₂ + 4NH₃ + O₂ | → | 3N₂ + 6H₂O |
| 4NO + 4NH₃ | → | 5N₂ + 6H₂O |
| 6NO₂ + 8NH₃ | → | 7N₂ + 12H₂O |

As these formulae indicate, SCR reduces nitrogen oxides in exhaust gases to nitrogen and water through the use of a catalyst and ammonia (“NH₃”), or an ammonia-producing compound like urea, as the reduction agent. Thus, SCR requires an ammonia source.

Various industrial and transportation processes might also benefit from the use of relatively small quantities of ammonia. Many NOx reducing applications used with large, stationary, industrial processes employ ammonia gas that is delivered into the exhaust stream before it reaches the catalyst bed. The ammonia is stored in gaseous form under high pressure or as a liquid, and the storage containers are periodically refilled or exchanged for a full reservoir. In practice, the need to store the compressed or liquid ammonia on-site may raise technical, safety, or security concerns that may make such an application of stored or compressed ammonia unacceptable.

Unattended internal combustion engines also may require devices and strategies to control NOx production and emissions. Many of these engines, as one example only, power generators for oil and natural gas wells, are often located in remote areas that are difficult to access routinely. The re-supply of ammonia or urea for NOx reduction to these locations may be expensive or impractical. Consequently, reducing or eliminating the need to re-supply ammonia or urea for NOx reduction for such engines would reduce the costs associated with transportation of required fluids.

An immediate need for devices and strategies to control NOx emissions is in internal combustion engines used in the transportation industry. Current mandates by the U.S. Environmental Protection Agency (“EPA”) require increasingly tighter control of NOx emissions from internal combustion engines.

The need to reduce the quantity of NOx emitted by diesel engines on trucks is addressed by various approaches. One way to reduce the NOx from such emissions is by injecting ammonia into the exhaust stream over a catalyst bed to form nitrogen gas and water. However, a need remains for a solution that reduces NOx in the exhaust gases without requiring the use of special high pressure gases or liquid solutions that must be purchased separately.

One solution for these unmet needs would be the on-demand synthesis of ammonia in miniature ammonia plants without storage of pure ammonia, or with minimal storage, that does not represent a significant safety or security hazard.

### SUMMARY OF THE INVENTION

The present invention comprises methods and apparatus to address these needs through the small scale generation of ammonia. In one embodiment, without limitation, the present invention comprises an on-board micro ammonia synthesis plant that offers a solution of NOx reduction without the hazards and inconvenience of carrying a secondary fluid on a motor vehicle. Thus, one embodiment of the present invention comprises a micro ammonia plant that controllably produces and stores ammonia that is used to reduce NOx levels in the exhaust streams of internal combustion engines. Other embodiments of the invention comprise, without limitation, methods and apparatus for the small scale generation of ammonia for industrial or agricultural uses.

### BRIEF DESCRIPTION OF THE DRAWINGS

The features and inventive aspects of the present invention will become more apparent upon reading the following detailed description, claims, and drawings, of which the following is a brief description.

FIG. 1 is a diagram of four components of the present invention.

FIG. 2 is a flow diagram of one embodiment of the present invention.

FIG. 3 is an example, without limitation, of one embodiment of the present invention usable on a motor vehicle.

FIG. 4 is a graph of operating pressure versus ammonia yield relating to the present invention.

### DESCRIPTION OF THE PREFERRED EMBODIMENTS

The present invention provides an alternative solution to the hazardous storage of ammonia through on-demand, load-following, or steady state synthesis of ammonia in a micro ammonia plant. Generated ammonia would immediately be used or stored in a non-hazardous state, as one example only, in a Temperature Swing Adsorption system using a zeolite. Embodiments of the invention comprise, without limitation, diesel and spark ignition motor vehicles, stationary and movable power generating sources, and other apparatus and processes where the controlled production of ammonia is desirable, as some examples only, the generation of ammonia-based fertilizers and in nitriding furnaces.

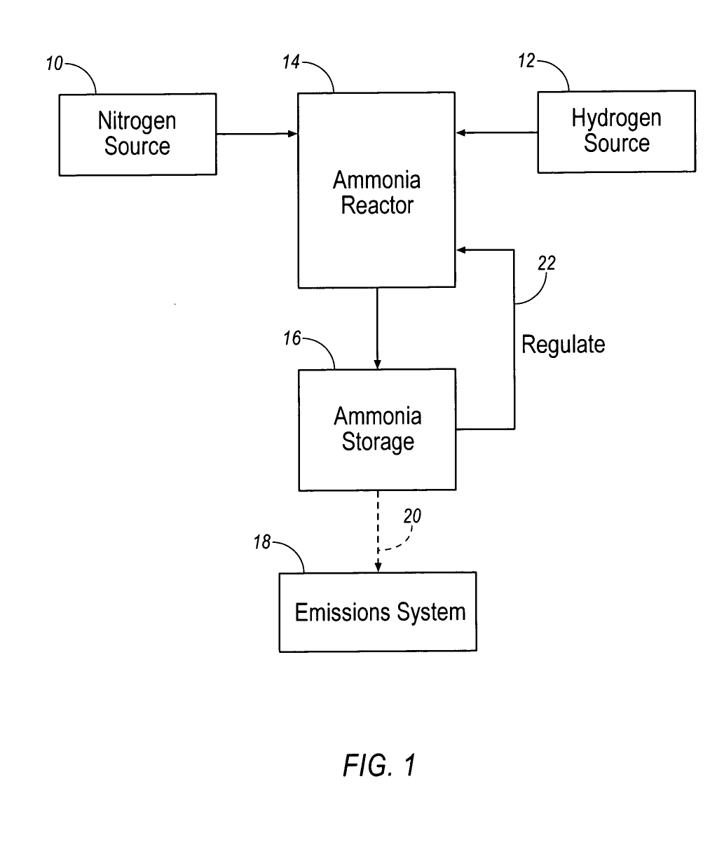

As shown in FIG. 1, in one preferred embodiment, without limitation, the invention is comprised of:
1. at least one nitrogen generation source 10;
2. at least one hydrogen source 12;
3. at least one ammonia reactor 14; and
4. means for ammonia storage, such as an ammonia storage container 16.

A mechanism for transporting the ammonia to an emissions system 18 is represented by dashed line 20. As described more fully below, regulation of ammonia production is shown by line 22.

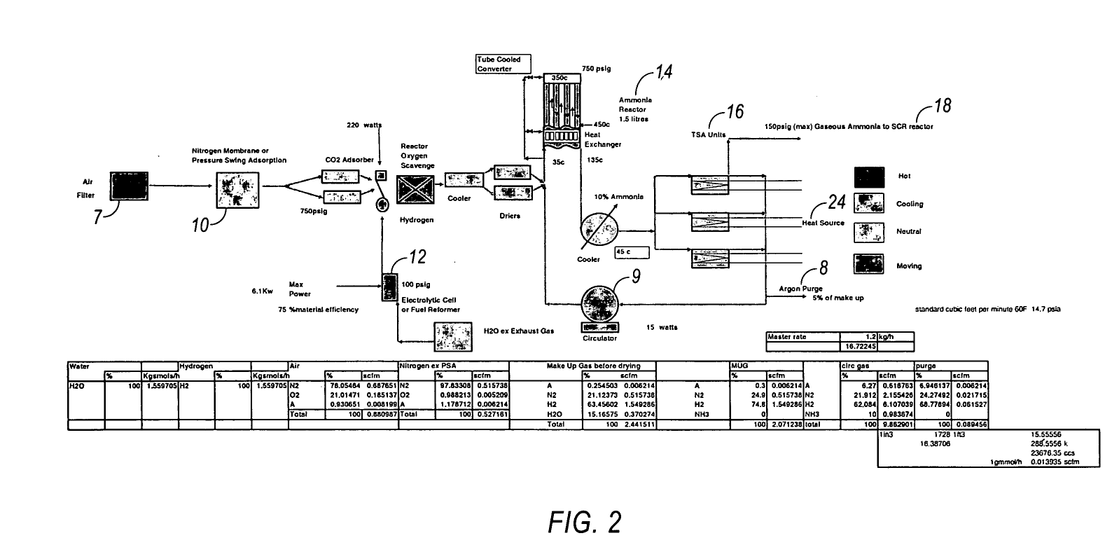

As shown in the embodiment of FIG. 2, without limitation, the nitrogen 10 and hydrogen 12 sources are connected with the ammonia reactor 14, where ammonia is created and transferred to storage container 16. The storage container 16 provides an ammonia source for use in the emissions system 18. In such a system, transients or turn-downs are minimized, which is unique in storage systems and requires no user intervention.

As indicated in the embodiment of FIG. 2, ammonia synthesis requires an accurate stoichiometric mixture of high purity hydrogen and nitrogen, which combine together at appropriate high temperature and pressure while in contact with a suitable catalyst, mixture of catalysts, or a series of different catalysts. The presence of catalyst allows the reaction to proceed at a higher rate and a significantly lower pressure and temperature than without catalyst, according to the following formula:
3H₂+N₂ (in the presence of catalyst, high T, high P)=2NH₃.

This is the rate limiting reaction.

The ammonia storage container 16 of the invention may be comprised of at least one zeolite source, which may be porous, with pore sizes created to a select a given molecular size, and shaped to hold and adsorb ammonia under normal operating conditions. The ammonia may be stored at ambient (e.g., 50 degrees C.) temperatures. Under use or demand conditions, the ammonia may be driven off from the storage system by controlled heating 24 of the catalyst.

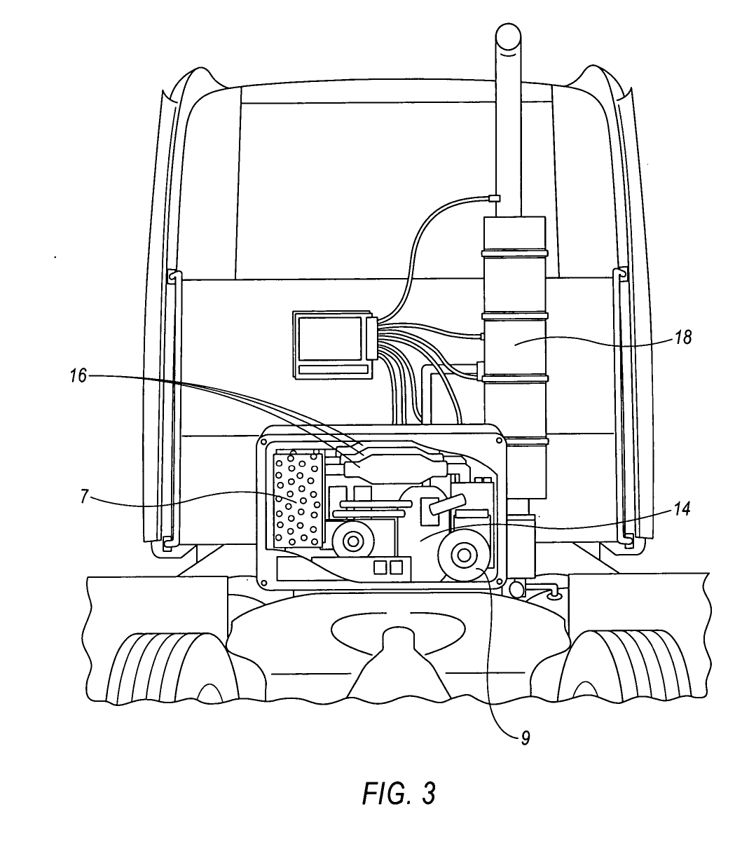

In some embodiments, the invention comprises one or more storage sources for storage system 16 (FIG. 3). In such embodiments, the invention may be operated through control systems (not shown) in order to select for the same or differential rates of charge or depletion of the individual storage sources, thus allowing the ammonia reactor 14 to be load-following or steady state, according to user-specified criteria.

In some embodiments, all catalysts are heated to appropriate operating temperature before becoming reactive. This permits operation in either a load-following state, for example, controlled by the engine output of NOx, or in a steady state of ammonia generation. Some embodiments comprise a control system (not shown) containing one or more algorithms that can be used to control or drive the ammonia reaction at peak conditions, for example, creating yield of the plant, with a variable speed motor in the compressor, and providing ammonia on demand.

In the present invention, ammonia may be synthesized from nitrogen, extracted from atmospheric air, and hydrogen, extracted from liquid or solid sources known to those of ordinary skill, such sources typically being significantly easier to monitor and control as compared to sources for high-pressure liquefied ammonia. In addition, both nitrogen and hydrogen could be, with the available technologies, generated only during the ammonia-making process. Consequently, in the period when ammonia is not manufactured, there would be no significant quantities of hydrogen or ammonia present in the system.

Nitrogen may be produced from a nitrogen source 10 such as atmospheric air according to one or more techniques know to those of ordinary skill in the art. One example involves a membrane separator (FIG. 2), and another example involves a pressure swing absorption unit (FIG. 2). Some embodiments of the invention may be comprised of at least one argon purge valve 8 to discharge argon and other contaminant gases accumulated in the system due to the use of air as a nitrogen source. Some embodiments may also be comprised of a circulator 9 which may be used to increase the efficiency and utilization of ammonia generated or stored in the invention.

The hydrogen source 12 may produce hydrogen for ammonia synthesis through one or more techniques including diesel fuel reforming and electrolysis, according to methods known to those of ordinary skill in the art. One downstream product of the SCR reaction is water, which, in some embodiments may be collected and circulated to the hydrogen source for use in hydrogen generation. Another source of water could come from condensing the water out of the exhaust stream and using that water for hydrogen generation. In some situations the water may need to be filtered to take out particulate matter or other undesirable species that would be inherent to condensed water from exhaust.

Ammonia reactors 14 of the invention are comprised of fluidized bed reactors made of iron oxide catalysts or other appropriate catalysts known to those of ordinary skill in the art. The invention may be comprised of one or more reactors 14, which may be temperature-controlled in some embodiments. The size of the reactors 14 may be selected according to the anticipated peak ammonia demand.

One often cited prerequisite for successful ammonia synthesis is the high purity of the reacting gases under high pressure. A higher pressure within a reactor 14 results, for the same catalyst, in a higher yield of ammonia, but limitations exist to the pressure, depending on the applications the micro ammonia plant is being used, due to safety and cost issues.

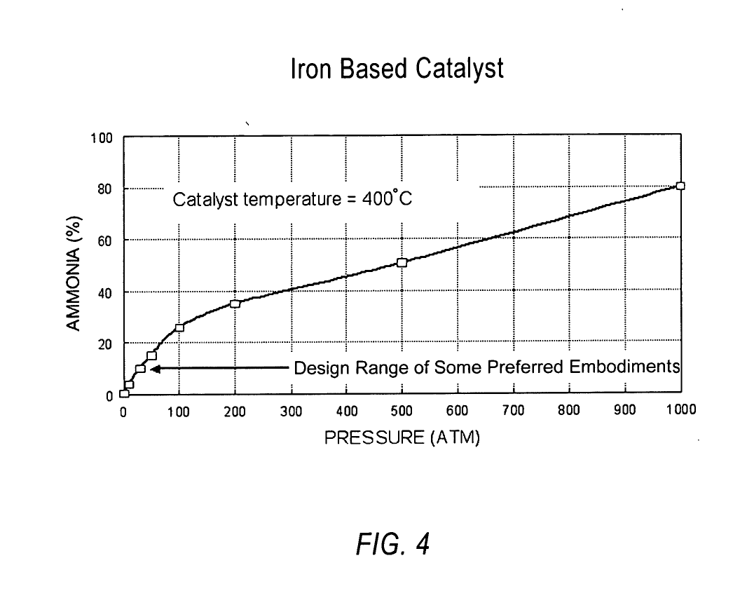

The present invention takes advantage of the use of lower pressures which results in a lower yield of ammonia which is still suitable for reducing NOx in the exhaust stream. The invention permits ammonia generation at a modest pressure, where lower yield may be acceptable, for example and without limitation, at approximately 7% efficiency (FIG. 4). At low yields, extra pumps can be used, and at high pressure, there may be low flow applications.

In some embodiments, the acceptance of a lower pressure range allows for the lower cost use of two or more compressors that would, as a group, have redundant capacity. By properly scheduling the running times of the compressors, one can prevent the unplanned interruption of the micro-plant operation caused by the compressor failure.

In some embodiments, in order to achieve the maximum reaction yield at lowered reaction pressures, the temperature in the catalytic reactor may be maintained at an optimum temperature through controls and heating or cooling system is maintained at the optimum. Maintenance of stable high temperature, or the ability to control the temperature within a narrow range, is an important requirement for performing the catalytic synthesis of ammonia in the mini plant, allowing steady yields and long, uninterrupted operation.

In addition, in order to avoid any runaway temperature excursions, the actual volume of the catalytic reactor can be divided in several segments that can be connected by simple tubular heat exchangers. In such an arrangement, the reaction mixture can be cooled down between reactor segments

One of the concerns for both safety and security is the quantity of the pure ammonia that can be released in the environment in the case of an accident. The present invention addresses this concern by two approaches:
A) The total quantity of ammonia that should be stored within the entire micro-plant should be kept at zero or at a minimum. If the ammonia storage is needed it should be sized to hold a supply of ammonia for the period of time that is necessary to start the micro-plant, and bring it up to the operating conditions; and
B) The design of the storage for ammonia may be made to minimize the release of ammonia to the environment in case of an accidental breakage.

Although certain preferred embodiments of the present invention have been described, the invention is not limited to the illustrations described and shown herein, which are deemed to be merely illustrative of the best modes of carrying out the invention. A person of ordinary skill in the art will realize that certain modifications and variations will come within the teachings of this invention and that such variations and modifications are within its spirit and the scope as defined by the claims.

1. An apparatus for the synthesis of ammonia, comprised of:
a. at least one nitrogen source,
b. at least one hydrogen source,
c. at least one ammonia reactor, and
d. means for storage of ammonia produced by the ammonia reactor,
each of elements (a) through (d) adapted to a motor vehicle,
whereby nitrogen and hydrogen from their respective sources react in the ammonia reactor to produce ammonia for use in the reduction of nitrogen oxide gases produced by the motor vehicle.

2. The apparatus of claim 1, where the motor vehicle is comprised of a diesel engine.

3. The apparatus of claim 1, where the motor vehicle is comprised of a spark ignition system.

4. The apparatus of claim 1, where the means for storage of ammonia is comprised of at least one zeolite.

5. The apparatus of claim 1, where the ammonia reactor is comprised of at least one iron oxide catalyst.

6. An apparatus for the synthesis of ammonia, comprised of:
a. at least one nitrogen source,
b. at least one hydrogen source,
c. at least one ammonia reactor, and
d. means for storage of ammonia produced by the ammonia reactor,
each of elements (a) through (d) adapted to an electrical power generating source,
whereby nitrogen and hydrogen from their respective sources react in the ammonia reactor to produce ammonia for use in the reduction of nitrogen oxide gases produced by the power source.

7. The apparatus of claim 6, wherein the power source is stationary.

8. The apparatus of claim 6, wherein the power source is movable.

9. An apparatus for the synthesis of ammonia, comprised of:
a. at least one nitrogen source,
b. at least one hydrogen source, and
c. at least one ammonia reactor,
each of elements (a) through (c) adapted for use in conjunction with means for ammonia-based fertilizer production,
whereby nitrogen and hydrogen from their respective sources react in the ammonia reactor to produce ammonia for use by the fertilizer production means.

10. The apparatus of claim 9, further comprised of means for storage of ammonia produced by the ammonia reactor which are adapted for use in conjunction with means for ammonia-based fertilizer production.

11. An apparatus for the synthesis of ammonia, comprised of:
a. at least one nitrogen source,
b. at least one hydrogen source, and
c. at least one ammonia reactor,
each of elements (a) through (c) adapted for use in conjunction with a nitriding furnace,
whereby nitrogen and hydrogen from their respective sources react in the ammonia reactor to produce ammonia for use in conjunction with the nitriding furnace.

12. The apparatus of claim 11, further comprised of means for storage of ammonia produced by the ammonia reactor which are adapted for use in conjunction with a nitriding furnace.

13. A method for the synthesis of ammonia on a motor vehicle comprising the steps of:
a. providing at least one nitrogen source,
b. providing at least one hydrogen source,
c. providing at least one ammonia reactor,
d. providing means for storage of ammonia produced by the ammonia reactor, and
e. reacting nitrogen and hydrogen from their respective sources in the ammonia reactor to produce ammonia for use in the reduction of nitrogen oxide gases produced by the motor vehicle.

14. The method of claim 13, where the motor vehicle is comprised of a diesel engine.

15. The method of claim 13, where the motor vehicle is comprised of a spark ignition system.

16. The method of claim 13, where the means for storage of ammonia is comprised of at least one zeolite.

17. The method of claim 13, where the ammonia reactor is comprised of at least one iron oxide catalyst.

18. A method for the synthesis of ammonia for an electrical power generating source comprising the steps of:
a. providing at least one nitrogen source,
b. providing at least one hydrogen source,
c. providing at least one ammonia reactor,
d. providing means for storage of ammonia produced by the ammonia reactor, and
e. reacting nitrogen and hydrogen from their respective sources in the ammonia reactor to produce ammonia for use in the reduction of nitrogen oxide gases produced by the power generating source.

19. The method of claim 18, wherein the power generating source is stationary.

20. The method of claim 18, wherein the power generating source is movable.

21. A method for the synthesis of ammonia in conjunction with the production of ammonia-based fertilizers comprising the steps of:
a. providing at least one nitrogen source,
b. providing at least one hydrogen source,
c. providing at least one ammonia reactor, and
d. reacting nitrogen and hydrogen from their respective sources in the ammonia reactor to produce ammonia for use by the fertilizer production means.

22. The method of claim 21, further comprising the step of providing means for storage of ammonia produced by the ammonia reactor.

23. A method for the synthesis of ammonia for a nitriding furnace comprising the steps of:
a. providing at least one nitrogen source,
b. providing at least one hydrogen source,
c. providing at least one ammonia reactor, and
d. reacting nitrogen and hydrogen from their respective sources in the ammonia reactor to produce ammonia for use in conjunction with the nitriding furnace.

24. The method of claim 23, further comprising the step of providing means for storage of ammonia produced by the ammonia reactor.

25. A method for treating exhaust gas from an internal combustion engine comprising the steps of:
a. providing a source of exhaust gas from an internal combustion engine,
b. providing at least one nitrogen source,
c. providing at least one hydrogen source,
d. providing at least one ammonia reactor,
e. providing means for storage of ammonia produced by the ammonia reactor,
f. reacting the nitrogen and hydrogen from their respective sources in the ammonia reactor to produce ammonia, and
g. treating nitrogen oxide gases produced by the internal combustion engine with ammonia produced by the ammonia reactor.

26. The method of claim 25, wherein the internal combustion engine is comprised of a diesel engine.

27. The method of claim 25, wherein the internal combustion engine is comprised of a spark ignition system.
